(19) United States
(12) Patent Application Publication
(10) Pub. No.: US 2016/0128801 A1
(43) Pub. Date: May 12, 2016

(54) CLEAR ALIGNER MANUFACTURING METHOD AND CLEAR ALIGNER SO MANUFACTURED

(71) Applicant: YI-SHIH KEKO, Taoyuan County (TW)

(72) Inventor: YI-SHIH KEKO, Taoyuan County (TW)

(21) Appl. No.: 14/535,668

(22) Filed: Nov. 7, 2014

(51) Int. Cl. A61C 7/00; B29C 65/70; A61C 7/08

(52) U.S. Cl. CPC A61C 7/002; A61C 7/08; B29C 65/70; B29K 2023/083

(57) ABSTRACT

A clear aligner manufacturing method includes the steps of collecting a user's dental data; planning out an upper and a lower teeth correction member according to the collected dental data; using the upper and lower teeth correction members to fabricate an elastic upper and an elastic lower correction splint, respectively; fitting the elastic upper and lower correction splints onto an upper and a lower fixing mold, respectively; heating the elastic upper and lower correction splints and an elastic connecting member to 180-280° C.; causing the elastic upper and lower correction splints to fuse into a top and a bottom, respectively, of the connecting member; and removing the upper and lower fixing molds from the upper and lower correction splints to obtain a clear aligner, which can apply sufficient force to correct the user's upper and lower teeth at the same time.

### FIELD OF THE INVENTION

The present invention relates to a method of manufacturing a teeth straightening device, and more particularly to a clear aligner manufacturing method, with which the clear aligner manufactured can apply sufficient force to correct a user's upper and lower teeth at the same time.

### BACKGROUND OF THE INVENTION

The currently available teeth straightening devices can be generally divided into two types, namely, dental braces and clear aligners. Both types of the teeth straightening devices progressively adjust the positions of teeth to achieve the purpose of teeth straightening. However, the two types of teeth straightening devices have their own merits and demerits.

For users, while the dental braces provide good teeth correction effect, they are not aesthetic and uneasy to clean, and tend to scratch and hurt the user's oral cavity.

On the other hand, while the clear aligners are aesthetic and easy to clean without the risk of scratching the user's oral cavity, the rigidity of their structure might fail to provide sufficient force for teeth correction, particularly during the initial stage of teeth correction treatment. More specifically, the conventional clear aligners progressively move the teeth through the rigidity of their structure. In the case the user's teeth are not easily moved, it is possible the structural rigidity of the clear aligner could not apply sufficient force against the user's teeth to correct the user's teeth positions. A user with extremely irregular teeth might not be suitable for wearing the conventional clear aligners. The conventional clear aligner might not be usable with users who have missing teeth or false teeth. And, the conventional clear aligners are usually more expensive than the dental braces. A further disadvantage of using the conventional clear aligners is the upper and the lower teeth are corrected with two separate clear aligners, which frequently results in malocclusion between the user's upper and lower teeth when the course of the teeth correction treatment is completed.

It is therefore desirable to develop a teeth straightening device that is aesthetic and easy to clean, provides good teeth correction effect without the risks of scratching the user's oral cavity and resulting in malocclusion, and is adapted for users having missing teeth and other unfavorable conditions.

### SUMMARY OF THE INVENTION

A primary object of the present invention is to provide a clear aligner manufacturing method, so as to manufacture a clear aligner that provides good teeth correction effect and has the advantages of being aesthetic, easy to clean, and safe for use without the risk of scratching the user's oral cavity.

Another object of the present invention is to provide a clear aligner manufacturing method, so as to manufacture a clear aligner that can be used to correct the user's other remaining teeth without being affected by missing teeth.

A further object of the present invention is to provide a clear aligner manufacturing method, so as to manufacture a clear aligner that does not cause malocclusion after the course of teeth correction treatment is completed.

To achieve the above and other objects, the clear aligner manufacturing method according to a preferred embodiment of the present invention includes the steps of (S1) collecting a user's dental data; (S3) planning out an upper teeth correction member and a lower teeth correction member according to the collected dental data; (S5) using the upper and the lower teeth correction member to fabricate an elastic upper correction splint and an elastic lower correction splint, respectively; (S7) fitting the elastic upper correction splint to a lower side of an upper fixing mold, and fitting the elastic lower correction splint to an upper side of a lower fixing mold; (S9) heating the elastic upper correction splint, the elastic lower correction splint and an elastic connecting member positioned between the upper and the lower correction splint to a temperature ranged between 180° C. and 280° C., so that the elastic upper correction splint, the elastic lower correction splint and the elastic connecting member are in a state of fusion; (S11) causing an outer periphery of the elastic upper correction splint to fuse into a top portion of the elastic connecting member, and causing an outer periphery of the elastic lower correction splint to fuse into a bottom portion of the elastic connecting member; and (S13) removing the upper and lower fixing molds from the upper and lower correction splints to obtain a clear aligner.

According to an embodiment of the clear aligner manufacturing method of the present invention, the elastic upper correction splint, the elastic lower correction splint and the elastic connecting member are made of ethyl-vinyl acetate (EVA).

According to another embodiment of the clear aligner manufacturing method of the present invention, the elastic upper correction splint, the elastic lower correction splint and the elastic connecting member are made of a polymer formed by mixing cotton fibers, artificial fibers and rubber.

According to the clear aligner manufacturing method of the present invention, in the step (S9), the elastic upper correction splint, the elastic lower correction splint and the elastic connecting member are preferably heated to a temperature ranged between 200° C. and 230° C.

The present invention also provides a clear aligner manufactured using the method of the present invention.

In brief, the clear aligner manufactured using the method of the present invention cooperates with the user's biting force to provide sufficient force for correcting the user's upper and lower teeth at the same time. In addition, the clear aligner manufactured using the method of the present invention has the advantages of being aesthetic, easy to clean, and safe for use without the risk of scratching the user's oral cavity. Further, the clear aligner of the present invention can be used with a user who has missing teeth, i.e. the clear aligner of the present invention can be used to correct other remaining teeth without being affected by the user's missing teeth. What is also important is the clear aligner of the present invention won't result in misalignment between the user's upper and lower teeth.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1 is a flowchart showing the steps S101 through S113 included in a clear aligner manufacturing method according to a preferred embodiment of the present invention;

FIG. 2a is a pictorial description of the step S105 shown in FIG. 1;

FIG. 2b is a pictorial description of the step S107 shown in FIG. 1;

FIG. 2c is a pictorial description of the step S109 shown in FIG. 1;

FIG. 2d is a pictorial description of the step S111 shown in FIG. 1;

FIG. 2e is a pictorial description of the step S113 shown in FIG. 1; and

FIG. 3 is a schematic view showing a user wearing the clear aligner manufactured according to the present invention.

### DETAILED DESCRIPTION OF THE PREFERRED EMBODIMENTS

The present invention will now be described with a preferred embodiment thereof and by referring to the accompanying drawings.

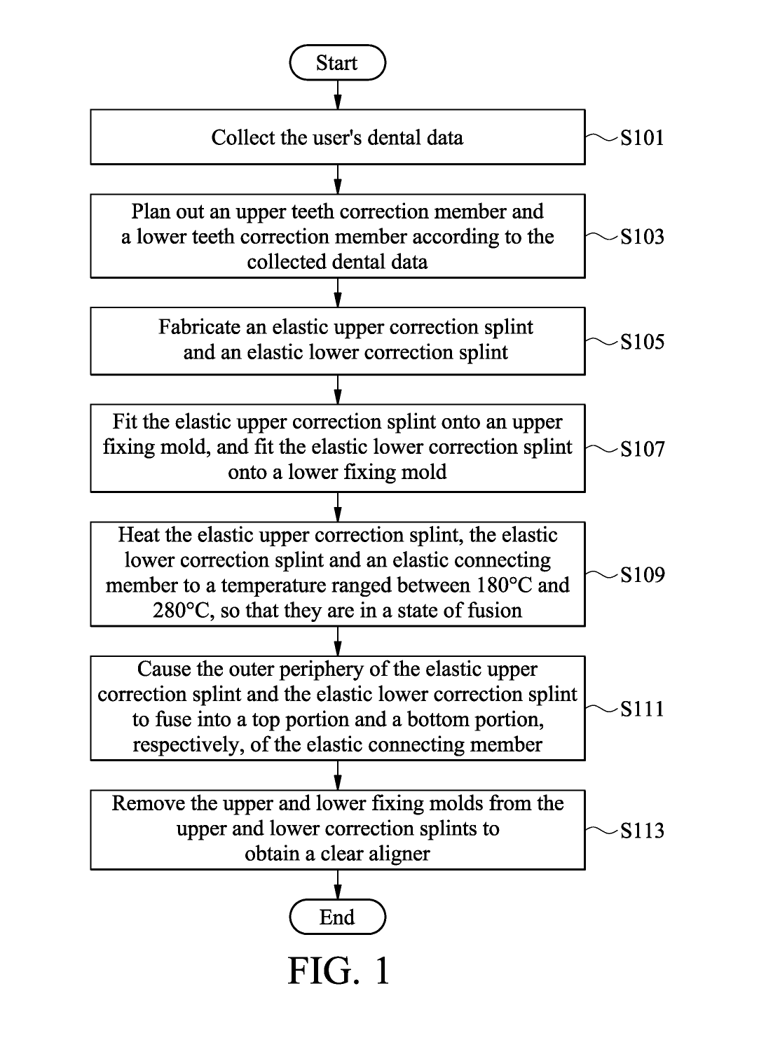

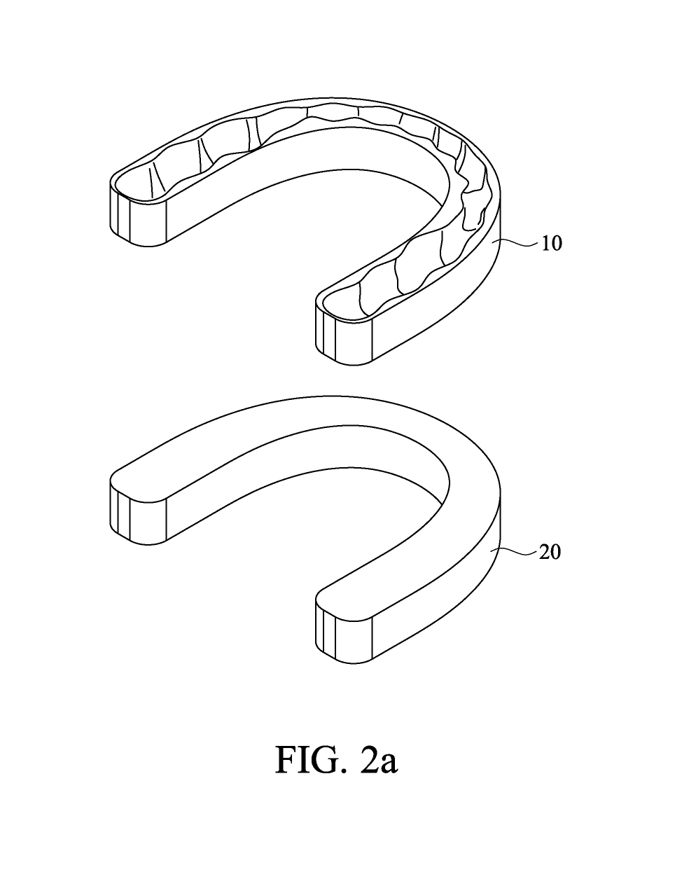

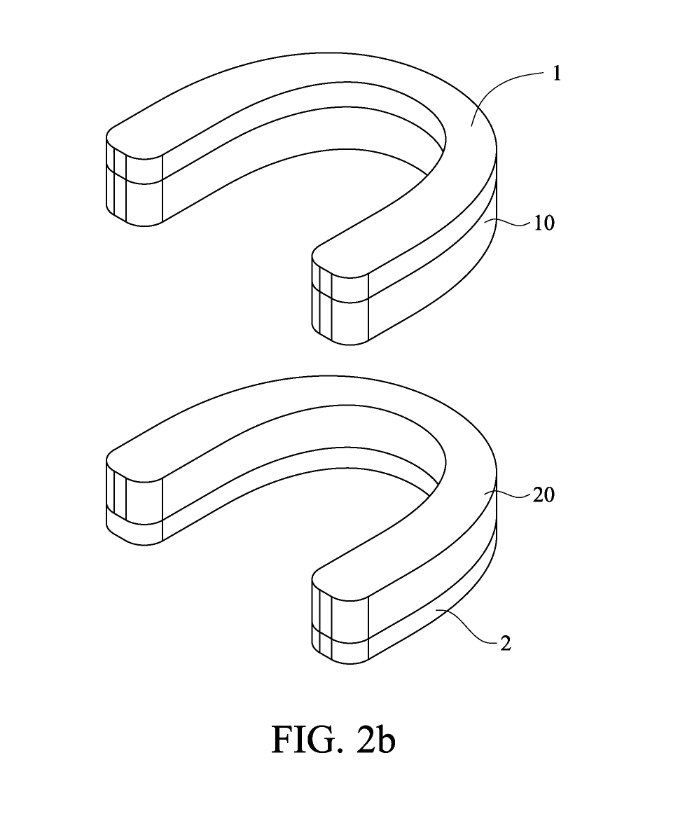

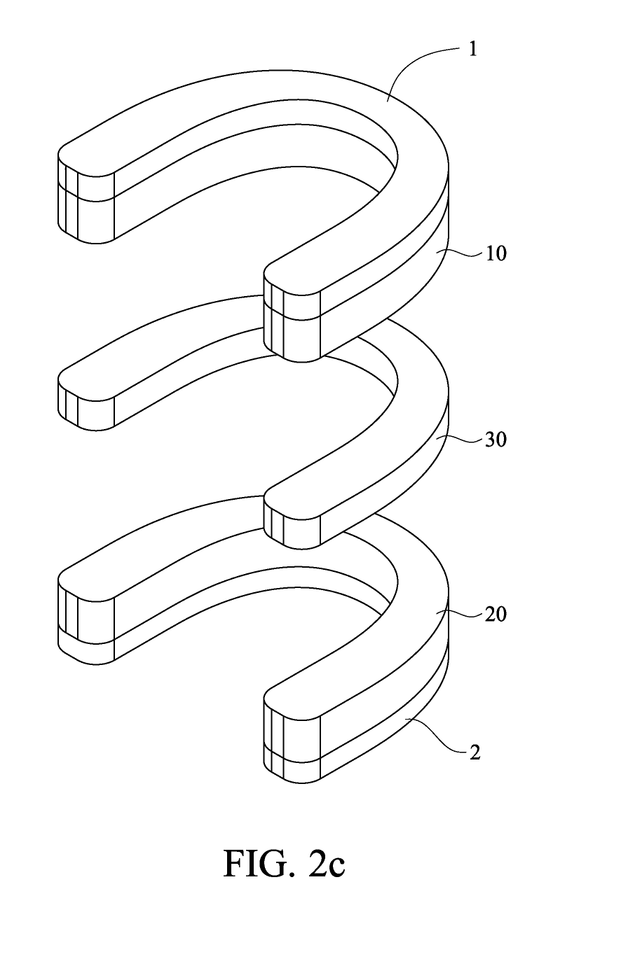

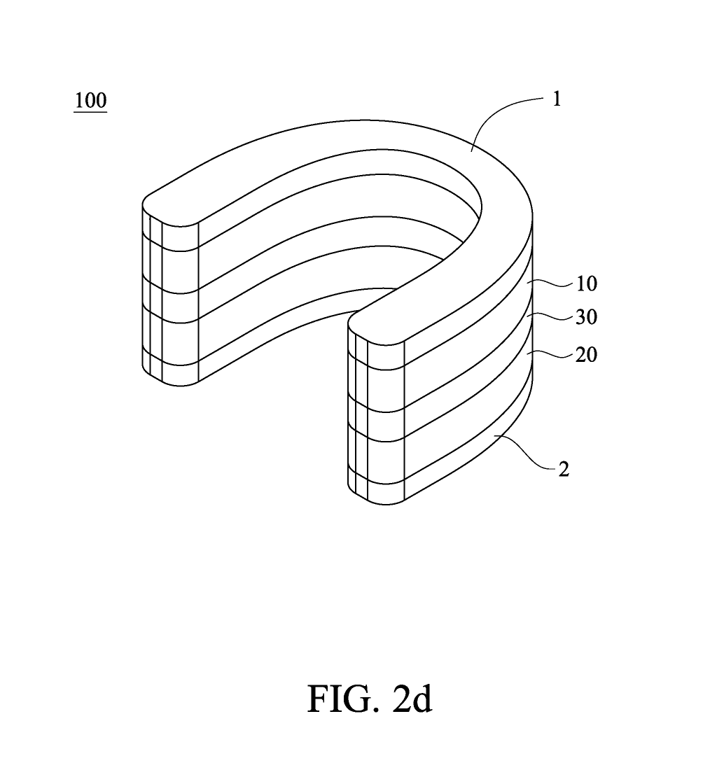

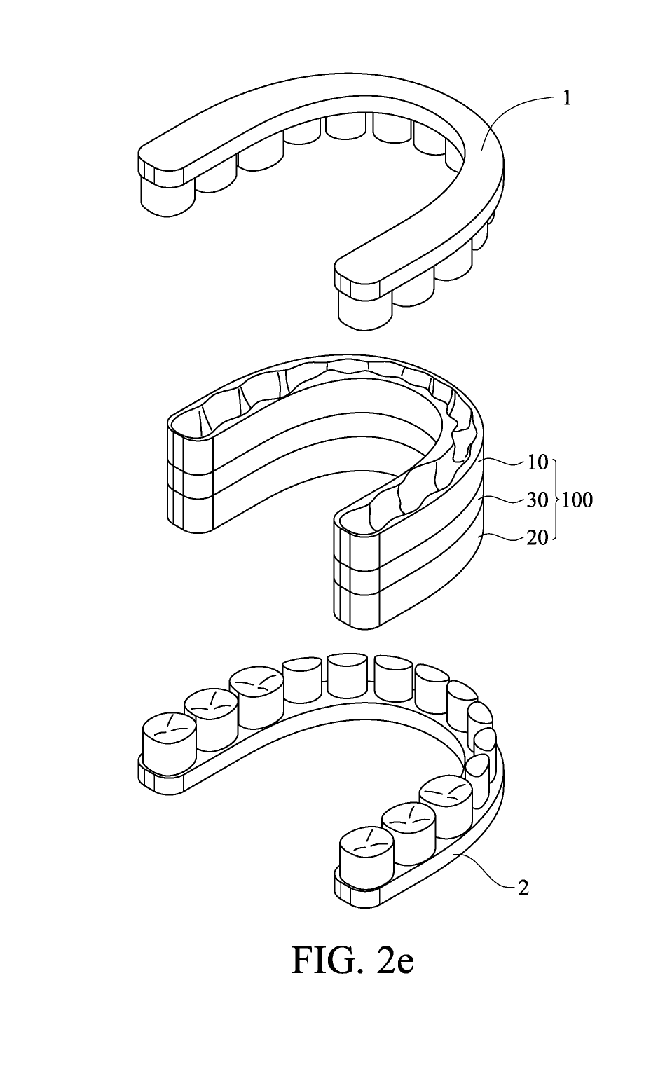

Please refer to FIG. 1, which is a flowchart showing seven steps included in a clear aligner manufacturing method according to a preferred embodiment of the present invention. These steps are explained below by referring to FIG. 1 and pictorial descriptions shown in FIGS. 2a to 2e.

In a first step S101 as shown in FIG. 1, a user's dental data are collected, which usually include, for example, the user's oral cavity photos and scanned files, occlusion records and other teeth-related data.

In a second step S103 as shown in FIG. 1, an upper teeth correction member and a lower teeth correction member are planned out according to the collected dental data. More specifically, the collected dental data is analyzed on a computer, so as to plan out the way of correcting the user's upper and lower teeth.

In a third step S105 as shown in FIG. 1 and pictorially described in FIG. 2a, an elastic upper correction splint 10 and an elastic lower correction splint 20 are fabricated according to the upper and the lower teeth correction member, respectively. Wherein, the elastic upper and lower correction splints 10, 20 are preferably made of a copolymer of ethylene and vinyl acetate, i.e. ethylene-vinyl acetate (EVA), or a polymer formed by mixing cotton fibers, artificial fibers and rubber, so that the elastic upper and lower teeth correction splints 10, 20 have a relatively high elasticity coefficient.

In a fourth step S107 as shown in FIG. 1 and pictorially described in FIG. 2b, the elastic upper correction splint 10 is fitted onto a lower side of an upper fixing mold 1, and the elastic lower correction splint 20 is fitted onto an upper side of a lower fixing mold 2.

In a fifth step S109 as shown in FIG. 1 and pictorially described in FIG. 2c, the connected elastic upper correction splint 10 and upper fixing mold 1, the connected elastic lower correction splint 20 and lower fixing mold 2, and an elastic connecting member 30 positioned between the upper and the lower correction splint 10, 20 are heated to a temperature ranged between 180° C. and 280° C., so that the elastic upper correction splint 10, the elastic lower correction splint 20 and the elastic connecting member 30 are in a state of fusion. Preferably, the heating temperature is ranged between 200° C. and 230° C. In addition, to match with the elastic upper correction splint 10 and the elastic lower correction splint 20, the elastic connecting member 30 is preferably made of a copolymer of ethylene and vinyl acetate, i.e. ethylene-vinyl acetate (EVA), or a polymer formed by mixing cotton fibers, artificial fibers and rubber.

In a sixth step S111 as shown in FIG. 1 and pictorially described in FIG. 2d, an outer periphery of the elastic upper correction splint 10 is rubbed or compressed to fuse into a top portion of the elastic connecting member 30, and an outer periphery of the elastic lower correction splint 20 is similarly rubbed or compressed to fuse into a bottom portion of the elastic connecting member 30, so that the elastic upper correction splint 10, the elastic lower correction splint 20 and the elastic connecting member 30 are united into one integral body. When rubbing or compressing the outer peripheries of the elastic upper and lower correction splints 10, 20 to fuse them into the elastic connecting member 30, the upper and lower fixing molds 1, 2 serve to prevent portions of the elastic upper and lower correction splints 10, 20 corresponding to the user's upper and lower teeth from becoming deformed.

Finally, in a seventh step S113 as shown in FIG. 1 and pictorially described in FIG. 2e, the upper fixing mold 1 and the lower fixing mold 2 are removed from the upper and the lower correction splint 10, 20, respectively, to obtain a clear aligner 100.

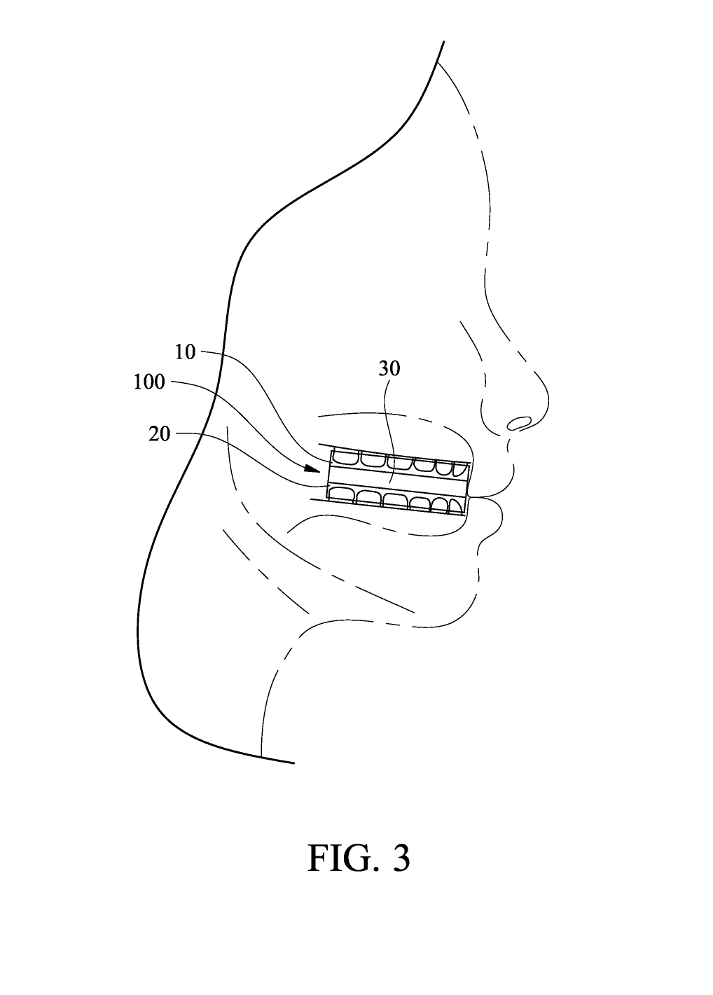

FIG. 3 shows the clear aligner 100 according to the present invention in use. When the user wears the clear aligner 100, the elastic structure of the elastic upper correction splint 10 and the elastic lower correction splint 20 applies a force against and accordingly moves the user's upper and lower teeth into desired positions. In other words, when the upper and the lower teeth have not yet been moved and rotated into positions planned by the elastic upper and lower correction splints 10, 20, the user's biting force against the clear aligner 100 and the limiting effect of the elastic structure of the upper and lower correction splints 10, 20 on the upper and the lower teeth together move and rotate the teeth into desired positions, so as to achieve the purpose of teeth correction. More specifically, the characteristic nature of the material for making the elastic upper and lower correction splints 10, 20 cooperates with the user's biting force to not only quickly force the upper and lower teeth to move and rotate into positions during the early stage of the course of teeth correction treatment, but also effectively maintain the upper and lower teeth correction effect during the later stage of the teeth correction treatment.

From the above description, it is understood the clear aligner 100 does not correct the upper and lower teeth via only its elastic structure, but must also rely on the user's own biting force. Therefore, the user's missing teeth do not affect the correction of other remaining teeth with the clear aligner 100. In other words, compared to the conventional clear aligners, the clear aligner 100 manufactured according to the present invention is suitable for more users who need teeth correction.

The elastic upper correction splint 10, the elastic lower correction splint 20 and the elastic connecting member 30 all have simple structure and smooth surfaces, and are advantageously made of a clear material. Therefore, the clear aligner 100 is aesthetic and easy to clean, and won't hurt the user's oral cavity when the user wears it.

When using the elastic upper and lower correction splints 10, 20 to correct the user's upper and lower teeth, respectively, the elastic connecting member 30 functions to maintain the relative positions of the elastic upper and lower correction splints 10, 20 to thereby avoid the condition of misalignment between upper and lower teeth after the course of teeth correction treatment is completed.

In summary, the clear aligner manufactured using the method of the present invention cooperates with the user's biting force to provide sufficient force for correcting the user's upper and lower teeth at the same time, so that the time needed to complete the course of teeth correction treatment can be shortened. In addition, the clear aligner manufactured using the method of the present invention has the advantages of being aesthetic, easy to clean, and safe for use without the risk of scratching the user's oral cavity. Further, the clear aligner of the present invention can be used with a user who has missing teeth, i.e. the clear aligner of the present invention can be used to correct other remaining teeth without being affected by the user's missing teeth. What is also important is the clear aligner of the present invention won't result in misalignment between the user's upper and lower teeth.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A clear aligner manufacturing method, comprising the following steps:
(S1) collecting a user's dental data;
(S3) planning out an upper teeth correction member and a lower teeth correction member according to the collected dental data;
(S5) using the upper and the lower teeth correction member to fabricate an elastic upper correction splint and an elastic lower correction splint, respectively;
(S7) fitting the elastic upper correction splint onto a lower side of an upper fixing mold, and fitting the elastic lower correction splint onto an upper side of a lower fixing mold;
(S9) heating the elastic upper correction splint, the elastic lower correction splint and an elastic connecting member, which is positioned between the upper and the lower correction splint, to a temperature ranged between 180° C. and 280° C., so that the elastic upper correction splint, the elastic lower correction splint and the elastic connecting member are in a state of fusion;
(S11) causing an outer periphery of the elastic upper correction splint to fuse into a top portion of the elastic connecting member, and causing an outer periphery of the elastic lower correction splint to fuse into a bottom portion of the elastic connecting member; and
(S13) removing the upper and lower fixing molds from the upper and lower correction splints to obtain a clear aligner.

2. The clear aligner manufacturing method as claimed in claim 1, wherein the elastic upper correction splint, the elastic lower correction splint and the elastic connecting member are made of ethyl-vinyl acetate (EVA).

3. The clear aligner manufacturing method as claimed in claim 2, wherein, in the step (S9), the elastic upper correction splint, the elastic lower correction splint and the elastic connecting member are preferably heated to a temperature ranged between 200° C. and 230° C.

4. The clear aligner manufacturing method as claimed in claim 1, wherein the elastic upper correction splint, the elastic lower correction splint and the elastic connecting member are made of a polymer formed by mixing cotton fibers, artificial fibers and rubber.

5. The clear aligner manufacturing method as claimed in claim 4, wherein, in the step (S9), the elastic upper correction splint, the elastic lower correction splint and the elastic connecting member are preferably heated to a temperature ranged between 200° C. and 230° C.

6. The clear aligner manufacturing method as claimed in claim 1, wherein, in the step (S9), the elastic upper correction splint, the elastic lower correction splint and the elastic connecting member are preferably heated to a temperature ranged between 200° C. and 230° C.

7. A clear aligner, being manufactured using the clear aligner manufacturing method as claimed in claim 1.
